(19) United States
(12) Patent Application Publication
(10) Pub. No.: US 2006/0217198 A1
(43) Pub. Date: Sep. 28, 2006

(54) Onsite fantasy sports game using onsite and network-based data collection and processing

(76) Inventor: Thor C. Johnson, Walnut Creek, CA (US)

Correspondence Address: HOGAN & HARTSON LLP, ONE TABOR CENTER, SUITE 1500, 1200 SEVENTEENTH ST, DENVER, CO, 80202, US

(21) Appl. No.: 11/091,197

(22) Filed: Mar. 28, 2005

(51) Int. Cl. A63F 13/00

(52) U.S. Cl. 463/40

(57) ABSTRACT

A system, and corresponding method, for operating fantasy sports games onsite at one or more facilities, such as restaurants, stadiums or arenas. The system includes a game management system that generates an input sheet for a fantasy sports game for a particular game period that defines game elements for a set of sporting events that occur during the game period. The system includes onsite game systems located at geographically dispersed facilities that are linked to a communications network to communicate with the game management system. The onsite game systems receive the input sheet, facilitate input of data for game players, and transfer the player data to the game management system. The mechanism generates results for each of the onsite game systems based on data for the set of sporting events and on the received player data. The mechanism transfers the facility-specific results to the onsite game systems for display.

### BACKGROUND OF THE INVENTION

1. Field of the Invention

The present invention relates, in general, to online fantasy sports games and leagues and, more particularly, to a method and system for operating a fantasy sports game at a particular location or “onsite” (e.g., at a restaurant or bar) including collecting and entering game player input, processing statistics from one or more sporting games or events, and concurrently displaying fantasy game results onsite to the game players.

2. Relevant Background

Playing fantasy sports has become increasingly popular in recent years with ready access to the Internet (or the Web) and with increasing publicity provided on television broadcasts of sporting events or games. To play fantasy sports, an individual selects their own all-star team of athletes. In a fantasy football example, the individual picks various athletes from different “scoring” positions, such as quarterback, running back, wide receiver and kicker. When these athletes perform well and score in a real NFL game, the individual scores points for their “drafted” all-star team. The object of the fantasy sports is to pick a better-scoring team of athletes than all of your friends or other participants.

Fantasy sports have been around for many years. About 30 years ago, fantasy people formed rotisserie baseball leagues in which individuals picked baseball players at various positions and manually tracked their statistics. The contests grew slowly across the U.S. with people getting together once a year prior to the beginning of a pro season to draft their teams and agree upon scoring and other game rules. For example, when fantasy football was initially played, a group of friends would gather in August or just prior to the NFL season and draft their teams. Then, each week, one person from this group would have the tedious task of manually compiling all the statistics from the newspapers and computing the point totals of each game player. As can be seen, the methods of playing fantasy sports that were originally used by fantasy sports players was very tedious and time-consuming, and often, limited the number of people interested in participating.

With the introduction of the Internet or Web to fantasy sports, an industry has developed providing fantasy sports games and has resulted in many changes to how the fantasy sports is played across the world. Fantasy sports programs are readily available on the Web. For example, the statistical calculations can now be done automatically by online software eliminating the need for the painstaking process of prior fantasy sports games. Additionally, numerous online game Web sites appeared that allowed people to sign up online and be able to weekly check their results and their current standings in online leagues. The online leagues generally mimic the original games, with players drafting their teams prior to a season and then, merely watching the progress of their team over the season of the team or league played.

Many fantasy sports Web sites began with free participation but relatively quickly moved to paid subscriptions. However, people appear more than willing to pay for the experience of playing fantasy sports without the time and hassle of calculating point totals and tracking player moves. Fantasy sports participation in the United States alone has reached over 16 million players, as estimated by the Fantasy Sports Trade Association.

More and more Web sites are provided each year offering fantasy sports games. The games range from professional football, baseball, basketball and hockey to golf, soccer, and collegiate games. Professional football is far and away the most dominant of all, but baseball and basketball have become increasing popular and other sports such as auto racing, fishing, and horse racing have also become the subject of online fantasy sports games. Many of the sites offer several combinations of games for just one sport.

As a result, most fantasy players play online or via Web-based games that are typically set up in leagues of players or groups of participants. The games run the duration of a sports season, such as the length of the professional football or baseball season. The coaches in the league gather online or in person once at the beginning of a season to allow the coaches to draft specific players from the corresponding real teams to form their fantasy team. In existing season-long fantasy games, each team typically has players designated as “starters” and “bench players”. As a result, each week, a fantasy game player or “coach” decides which players will be “activated” and which ones will sit on their bench. Bench players do not score points for their team as only active players can score points. Also, the coaches may, in some fantasy leagues or games, periodically make trades or acquisitions to change their team. To be successful, the season-long fantasy game requires a significant time commitment from the player or coach. For example, the coach may have to perform weekly research on match-ups, injury reports, bye weeks, grass versus turf statistics, weather conditions, statistical trends, potential trades, and more to allow them to make starter versus bench decisions and trade decisions.

From the previous discussion, it can be seen that the six basic activities of a fantasy sports season include: (1) analysis and pre-season preparation for the draft; (2) live draft; (3) set lineup each week; delineating which players are starters; (4) trade players and improve your team during the season by dropping some players and adding some others; (5) watch the professional games and monitor your statistical results; and (6) review results with friends and other game players. Many fantasy players find that the live draft, watching the games, and talking about the results are the most fun and exciting elements of playing fantasy sports. With the advent of the online games, though, many fantasy sports players find that they do not have the opportunity to discuss the results with other players or at least, miss face to face discussions. Further, as with the original fantasy games, players are typically forced to wait an entire season to learn who the winner is or to obtain results of the fantasy game. Also, many players or potential players are turned off by the season-long commitment of fantasy sports but still want the excitement that comes from picking a team and watching games in which their fantasy team is “playing.”

Hence, there remains a need for an improved method and system for providing fantasy sports to participants or players that addresses the demand of players for a shorter time commitment fantasy sports game but that enhances the ability of the players to have face-to-face discussions about the results and also provides more timely feedback regarding the results or winners. Preferably, such a method and system would retain the desirable features of existing online fantasy sports games including collecting data from live sporting events or games and processing of statistics to determine points awarded to the fantasy sports players.

### SUMMARY OF THE INVENTION

The present invention addresses the above and other problems by providing a method and system for providing a fantasy sports game at an onsite facility, such as a restaurant, bar, stadium or arena, with online or Web-based data processing and computer-based support. The method and system provides a unique fantasy sports game experience within the onsite facility that can be thought of as being delivered via a game management system that is linked to the facility and to a communications network, such as the Internet.

In a football embodiment of the invention, for example, the method involves providing weekly game sheets to players that can be downloaded and printed at the onsite facility via the game management system. Players (e.g., restaurant customers) provide their selections on the sheets, which are entered in an onsite game system at the onsite facility prior to a game period (e.g., the time period corresponding to an early or late set of games on a Sunday for U.S. professional football). The player data is transferred to the game management system for storage and processing including updating of game results (or points awarded to the players). The method may include providing current game results to the onsite facility during the game period and displaying a leaderboard at the onsite facility via the onsite game system to present the players' game names, selections, and game results for all to see in the facility (e.g., restaurant). During the game period, real time statistics flow from the game management system to the leaderboard via the onsite game system to give the onsite facility updated player standings throughout the game period including the final results calculated at the end of the game period (i.e., after the last of the “real” games being played during the game period). In this way, the method and system of the invention provides a fantasy sports environment in which players only have a short term commitment of 3 to 4 hours (for the football example) while enjoying the excitement of picking their team, quickly tracking results, being with others playing the same fantasy sports game, and receiving near immediate feedback as to the results of their selections.

More particularly, a system is provided that is adapted for operating fantasy sports games onsite at one or more facilities, such as restaurants, bars, stadiums or arenas and the like. The system includes a game management system linked to a communications network, such as the Internet, that has memory and a game management mechanism(s). The game management mechanism generates an input sheet (or “game sheet” or input form) for a fantasy sports game for a particular game period and stores the input sheet in the memory. The input sheet defines a set of game elements (e.g., players or other features that can be selected or drafted as part of the fantasy sports game) for a set of sporting events (e.g., football, basketball, hockey, baseball, soccer, or other games or events) that are scheduled to occur during the game period (e.g., the early or the late games for professional football or the like). The system further includes a plurality of onsite game systems each located at geographically dispersed facilities that are linked to the communications network to enable communication with the game management system. Each of the onsite game systems is adapted for receiving the input sheet over the network, for inputting player data for game players, and transferring the entered player data to the game management system. This input may be manual data entry or could be automated entry directly from the end user through any number of input devices, including keyboards, personal computers, personal digital assistants, pagers, cell phones, portable email devices, etc. The game management mechanism generates game results for each of the onsite game systems at each of the facilities (i.e., facility-specific game results) based on data for the set of sporting events and based on the received player data. The game management mechanism then transfers the facility-specific game results to each of the onsite game systems.

In some embodiments, the game management mechanism also generates a leaderboard for each of the facilities that includes facility-specific information (such as sponsor information) and that includes the game results specific to that facility. The leaderboards are transferred to the onsite game systems which include display devices and operate to display the leaderboards on the display devices. In some cases, the game management mechanism is adapted to combine the game results for a predefined set of the facilities (such as a chain of restaurants or bars) and the leaderboards for this predefined set of the facilities is generated to include the combined game results. The game period is typically less than 24 hours or a day and more typically, is defined as having a starting time corresponding to an earliest starting time for the set of sporting events and an ending time corresponding to a latest ending time for the set of sporting events. Preferably, the game results are determined periodically during the game period to allow updated leaderboards to be displayed at the facilities and also after completion of the game period to allow a set of “winners” to be identified and prizes (which may be specific to operation of the facility, specific to the set of facilities, and/or specific to sponsors of the fantasy sports game), and in some cases, the onsite game system is adapted to select the winners and assign prizes (with or without facility employee or game commissioner interaction).

### BRIEF DESCRIPTION OF THE DRAWINGS

FIG. 1 illustrates in block form a streaming data storage and serving system according to one embodiment of the invention;

FIG. 2 illustrates a process for triggering a COPY-ON-READ (COR) operation such as may be performed during operation of the system of FIG. 1;

FIG. 3 illustrates in block form a selection of streams from a candidate data object for use in a COR operation showing the use of distributed stream addresses;

FIG. 4 illustrates an exemplary process for processing a received request for a data stream, such as may be performed during operation of the system of FIG. 1;

FIG. 5 illustrates an exemplary process for performing a stream migration according to an embodiment of the invention, such as may be performed during operation of the system of FIG. 1; and

FIG. 6 illustrates in block form an interruption of an input stream for a COR operation which results, at least temporarily, in a partial replica of a data object.

### DETAILED DESCRIPTION OF THE PREFERRED EMBODIMENTS

The invention is generally directed to a method, and corresponding systems, for operating a fantasy sports game at a particular facility (i.e., an “onsite facility”). The method differs from prior fantasy games because it is only run for a relatively short period such as for a 3 to 5 hour period, such as the time corresponding to a set of early professional football games or a set of basketball, baseball, or other games, but in most cases for less than one day. The game period preferably is selected to cover a complete game but may be less and is selected to allow game players to complete their gaming experience at the onsite facility (such as a restaurant, bar, or the like). The method includes collecting game player selections prior and entering the data at the onsite facility and then, transferring the data to a network-lined game management system.

Once the game period begins, the game management system acts to gather data from live or real sporting events or games, e.g., competing player statistics from the games or events. On a periodic or nearly ongoing basis, the game management system determines game results for the game players and generates a leaderboard (e.g., a web page or the like) that is transmitted over a communications network to the onsite facility. The onsite facility uses an onsite game system to process the leaderboard and display it on one or more monitors at the onsite facility. The method differs from other fantasy games because the leaderboard is created to be specific to the onsite facility by including results for the game players for whom data was entered via the facility or linked to the facility. The leaderboard also may include results for employees of the facility and for other facilities that are linked or grouped with the onsite facility (such as other restaurants in a chain or under similar ownership or otherwise partnering for the game). The leaderboard further may include game sponsors data that is specific to the onsite facility. Additionally, the method of the invention differs from other fantasy games because at the end of the game period a final leaderboard is generated with the final game results, which includes the top game players in each game category such as players at the onsite facility, players at a group of facilities including the onsite facility, and employees. Prizes may be announced in the leaderboard or otherwise at the onsite facility for the game period. As will become clear from the following description, the fantasy sports method allows game players to enjoy challenge of picking a fantasy team, to nearly immediately receive feedback for their selections, and to learn to the overall results of the game period in a short time frame (such as less than 5 hours) rather than being forced to wait until the end of a sports season.

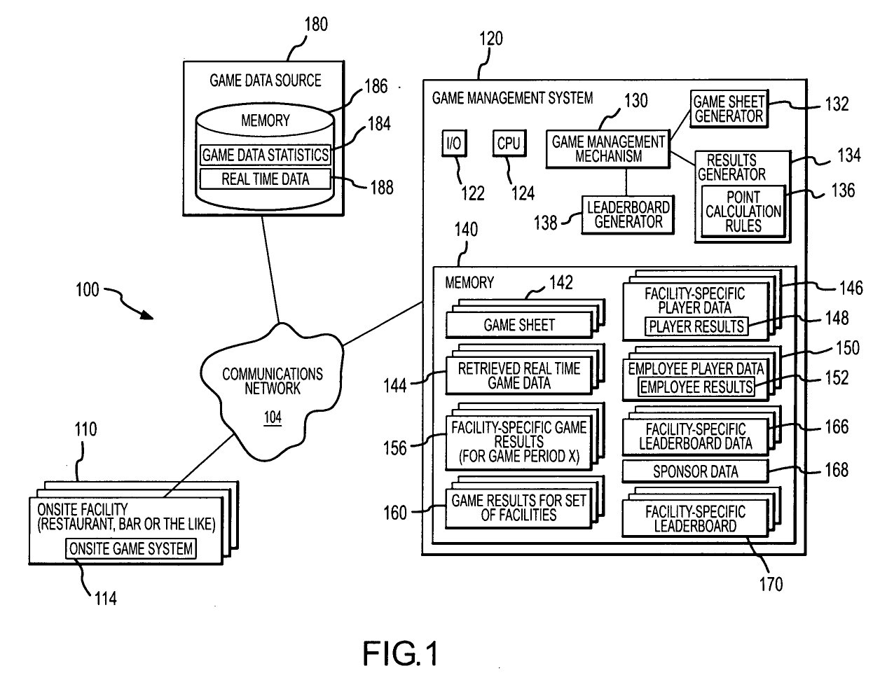

FIG. 1 illustrates a system for operating an onsite fantasy sports game 100 according to one embodiment of the invention. In the following discussion, computer and network devices and storage devices, such as the software and hardware devices within the system 100 are described in relation to their function rather than as being limited to particular electronic devices and computer architectures and programming languages. To practice the invention, the computer, data entry, display, and storage devices may be any devices useful for providing the described functions, including well-known data processing and communication devices and systems, such as application, database, web, and entry level servers, midframe, midrange, and high-end servers, personal computers and computing devices including mobile computing and electronic devices with processing, memory, and input/output components and running code or programs in any useful programming language, and server devices configured to maintain and then transmit digital data over a wired or wireless communications network. Data storage devices and memory are described herein generally and are intended to refer to nearly any device and media useful for storing digital data such as tape-based devices and disk-based devices, their controllers or control systems, and any associated software. Data, including transmissions to and from the elements of the system 100, typically is communicated in digital format following standard communication and transfer protocols, such as TCP/IP, FC, FC-AL, SCSI, PCI, HTTP, HTTPS, FTP, and the like, or IP or non-IP wireless communication protocols.

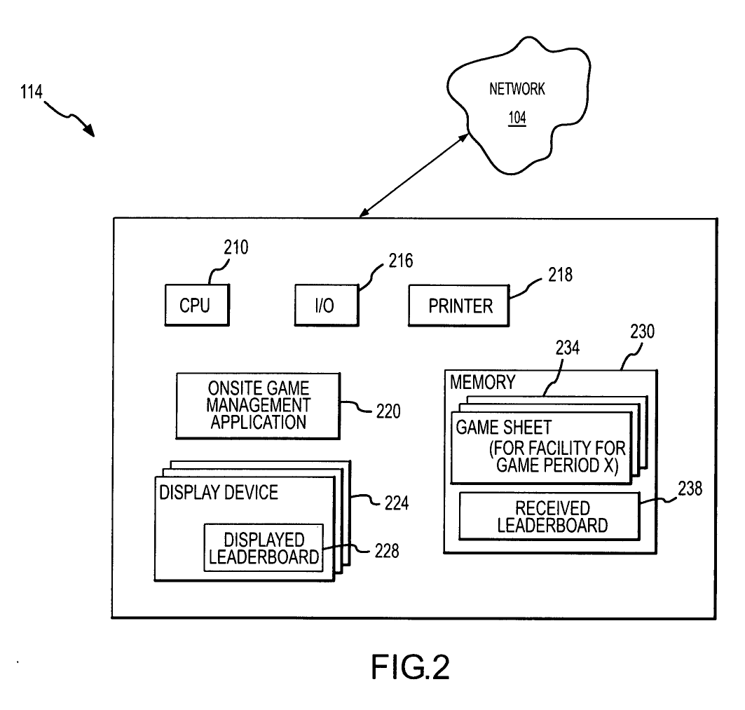

FIG. 1 illustrates an exemplary system 100 that is configured or adapted to operate with the onsite gaming methods of the present invention (see, for example, the method 800 of FIG. 8). Generally, the system 100 is configured to provide online or network-based support for a fantasy sports game being run or provided at one or more onsite facilities 110, which are shown to be restaurants, bars, or the like. As will be explained with more detail with reference to FIG. 2, each onsite facility 110 includes an onsite game system 114 that functions to allow game player data to be input and transferred over the communications network 104 (e.g., the Internet, a LAN, a WAN, or the like) to a game management system 120 and to also receive game results in the form of leaderboards from the game management system 120. The onsite game system 114 further functions to display the leaderboard such as on one or more display devices (such as television or other similar devices). Only one onsite facility 110 may be included in the system 100 but more typically, numerous onsite facilities 110 are included and served in parallel or concurrently. For example, a chain of sports bars or restaurants may each be linked via the network 104 to game management system 120, and prior to a game period, each facility 110 would provide player data to the game management system 120. The game management system 120 then operates to determine game results for each of the facilities 110, to generate facility-specific results (i.e., results for the players at or linked to each facility 110), and to generate facility-specific leaderboards that are transmitted to the onsite facilities 110 for display by the onsite game system 114 at the facilities 110. The leaderboards may include data that is determined based on game players from two or more of the facilities 110 that are grouped into a set, such as a chain of restaurants or bars or otherwise partnered for the purposes of the onsite fantasy sports game being presented by the system 100.

As shown in FIG. 1, the onsite facility 110 is connected to the game management system 120 via the network 104. The management system 120 functions to provide online or network-based support for the onsite game system 114 that allows game results to be determined and generated during the occurrence of one or more live or real sporting events or games. The data for the games may be collected directly by the system 120 but more typically, as shown, a game data source 180 is included in the system 100 that functions to gather game data statistics 184 that it stores in memory 186 and periodically transmits via network 104 to the game management system 120. The game data statistics 184 includes the data used by the game management system 120 to calculate points or game results for the game players at each of the onsite facilities 110, e.g., in a football example, touchdowns scored by players, yards run by players, yards thrown by players, catches made by players, points and yards given up by teams, and the like. The game data source 188 may also act to collect real time data 188 (or this function may be performed by a different service not shown) that is also fed to the game management system 120 for inclusion in leaderboards. For example, current scores of ongoing games, current statistics for ongoing games, and the like may be included in the real time data that optionally may be included in leaderboards generated by the game management system 120.

The game management system 120 includes an I/O device(s) 122 allowing it to interface with the network 104 and with operators of the system 120 and a processor 124 for managing memory 140 and running one or more software applications. The software application or programs include a game management mechanism 130 that operates to process player data from the onsite facility 110 and game data statistics 184 from the game data source 180 to generate game results and in turn, leaderboards containing game results for the facility 110. To this end, the game management mechanism 130 may include or use a game sheet generator 132 that operates to generate input or game sheets that are transmitted to the onsite game system 114 for use in gathering player data at the onsite facility 110. A results generator 134 which utilizes point calculation rules 136 to determine player and game results by processing the player data and the game data statistics, which are stored in memory 140 as 144, 146, and 150. The point calculation rules 136 will vary with the sport or game that is the subject of the fantasy sports game run by the system 100 and is not limiting to the present invention (e.g., can vary widely to practice the present invention). A leaderboard generator 138 is also provided that functions to process the game results, sponsor data, leaderboard data, and other data to generate a leaderboard (e.g., a web page or the like) that is transmitted to the onsite game system 114 by the game management mechanism 130.

As shown, memory 140 stores a variety of information or data that is used to provide Web-based support for the onsite game system 114. Generated game sheets 142 are stored in memory 140 for later transmission to the onsite facility 110. The game sheets 142 are generated by the game sheet generator 132 and configured for use in collecting player data. Player data may be gathered via the game sheets 142 for players at each facility and when received via network 104 from the onsite game system 114 is stored in memory as element 146. In some cases, the system 100 may be configured to track results for employees at the onsite facility 110 and in these cases, employee player data 150 is stored in memory 140, too. During a game period, retrieved or received real time game data 144 is stored in memory 140 and may include statistics 184 used by the results generator 134 in calculating player results 148, 152 and may include real time data 188 that is used by the leaderboard generator 138 in generating the facility-specific leaderboard 170 (such as for provision as a streaming banner or portlet of current information of live or real events or games).

During the game period (e.g., time periods for early and/or late professional football games in the United States), the results generator 134 periodically or nearly continuously (such as whenever new data 144 is received) calculates player results 148, 152 and these are used to determine facility-specific game results 156 for each facility 110 participating in the fantasy game corresponding to the current game period. For example, the results generator 134 may use the point calculation rules 136 and game data 144 to determine the points scored by each of the players associated with the player data 146, 150 to determine the player results 148, 152. The results generator 134 then uses these points or results 148, 152 to determine game results 156 for each facility 110, such as a listing or standings for each facility providing the players name/ID along with their point totals that may be arranged by total points or some other criteria. Further, the results generator 134 may determine game results 160 for a set of the facilities 110, such as those of a chain or under common ownership, and these results 160 may include a subset of all the facility results 156, e.g., the top ten or some other predetermined number of player results 148, 152 in the game results 156.

The memory 140 further may store a set of facility-specific leaderboard data 166 that may include information such as the name and location of the facility 110 and the like. The system 100 may be configured to allow advertising or marketing information to be included in a system wide basis (e.g., in all or most leaderboards 170) or in a more targeted fashion (e.g., for a particular type of sporting event, for a particular geographic area, for a particular facility or set of facilities, or the like). To this end, the memory 140 stores sponsor data 168 that preferably includes an indicator or filter value that identifies which leaderboards 170 will include the sponsor data 168.

The leaderboard generator 138 functions during the game period to generate facility-specific leaderboards 170 based on the facility-specific game results 156, the facility-specific leaderboard data 166, and the sponsor data 168. In one embodiment, an HTML document or a Web page is created by combining this information and the HTML document or Web page are transmitted via the network 104 to the onsite game system 114, which in turn operates to display the received leaderboard 170. The leaderboard 170 may also include game results for a set of facilities 160 and may also include real time game data 144, such as current scores, statistics, or the like from ongoing games or events pertaining to the fantasy game during the game period (or from an earlier game period, e.g., football scores and statistics from the earlier game period). The leaderboard 170 is typically finalized or a final one of the leaderboards 170 is generated after all the events or games of a game period have ended as determined by the game management mechanism 130 or alternatively, at a fixed time (e.g., use game results calculated as of a fixed time to allow a known end time for the game period rather than relying on possible game or event extensions such as overtime, extra periods, extra innings, or the like). The final leaderboard 170 may be configured to indicate a set of “winners” having the highest scores, such as the top 1 to 5 or more players. These leaderboards may also include prizes for the winners, such as may be provided by the facility-specific leaderboard data 166, sponsor data 168 (i.e., sponsors may provide the prizes), or prizes for a set of facilities (e.g., a chain of restaurants may provide prizes for chain-wide winners of the fantasy game).

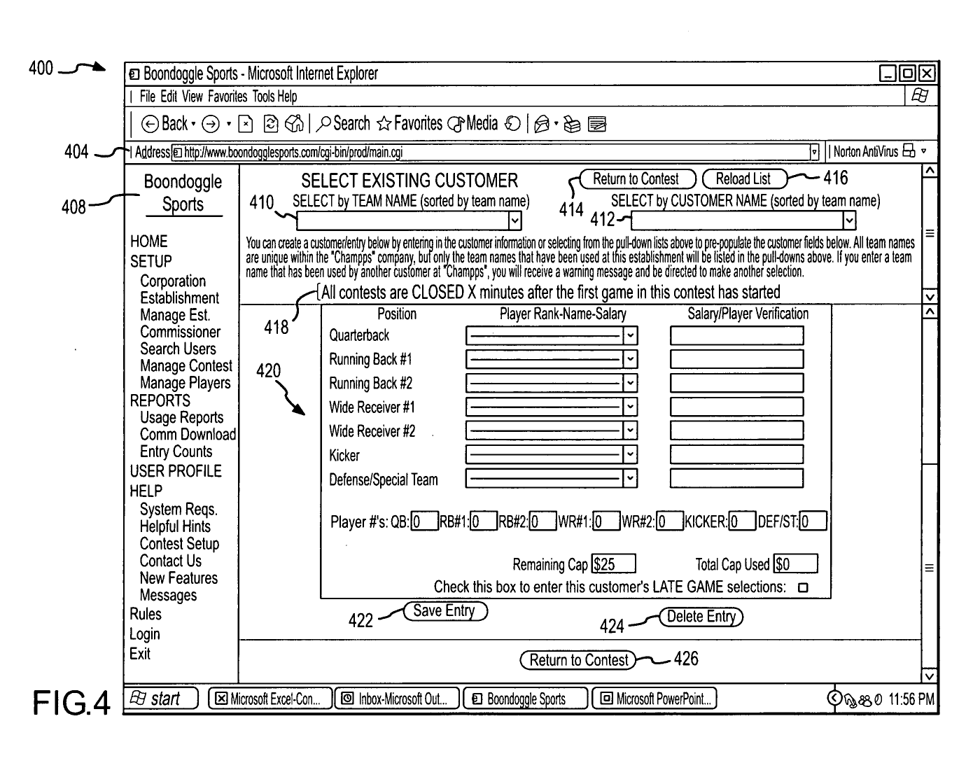

FIG. 2 illustrates on onsite game system 114 in more detail. As shown, the game system 114 includes a processor 210 for managing memory 230 and other operations of the system 114. An I/O device(s) 216 is provided to interface with the network 104 and to allow an operator (such as an employee of the facility 110 or a “game commissioner”) to enter player data from game sheets filled in by customers or players at the facility 110 (or remotely via network 104). A printer 218 is provided for printing out copies of the game sheets 234 received from the game management mechanism 130 and stored in memory 230. An onsite game management application 220 is provided in the system 114 and run by CPU 210 to provide a user interface via I/O 216 for allowing employees or commissioners to interact with the onsite game system 114, as is explained in more detail with reference to FIGS. 4-6. A display device 224 is provided for displaying leaderboards 228, and in an exemplary embodiment, the display devices 224 are televisions, large screen display devices, or the like that are configured to receive input from the application 220. The input includes received leaderboards 238 stored in memory 230 (or directly transmitted to the display device 224) when received from the game management system 120.

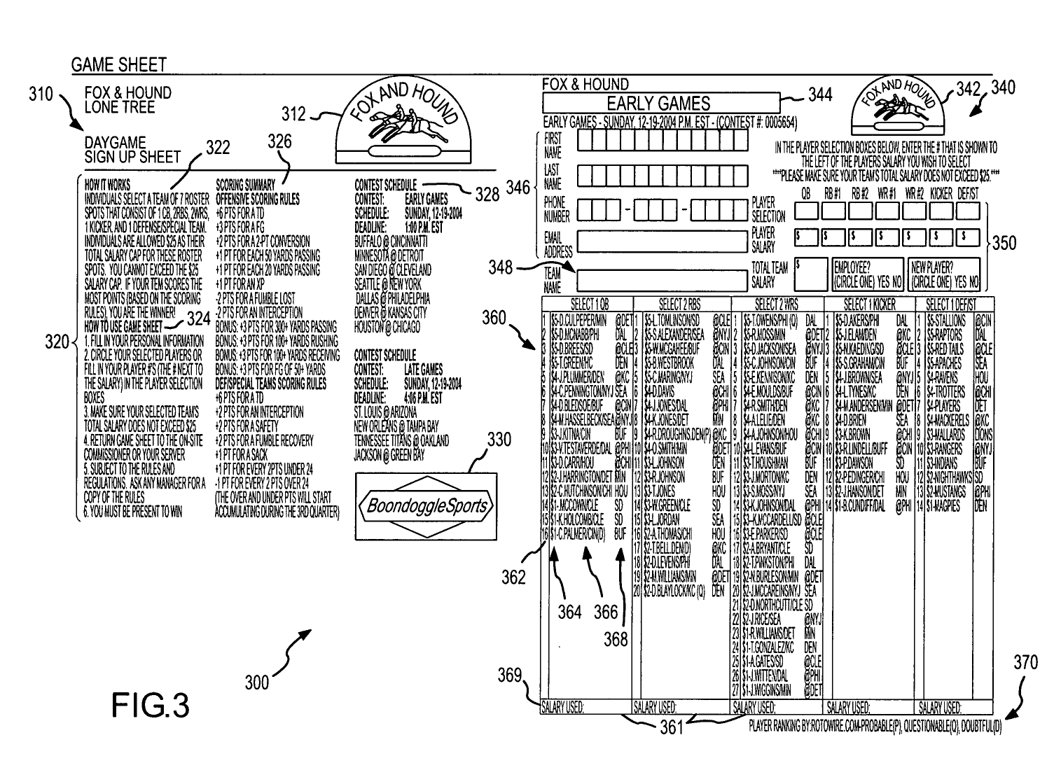

With an understanding of an exemplary system 100 for implementing fantasy game methods of the invention, it may now be useful to describe specific forms, interfaces, and displayed leaderboards that can be used to effectively practice the invention. A game sheet 300 is shown in FIG. 3 that may be created by the game sheet generator 132 and transmitted to the onsite game system 114 for its use in collecting player data (e.g., data 146, 150 that is transmitted to the game management system 120 by the onsite game system 114). In one embodiment, the game sheet 300 is printed via the printer 218 by the onsite game management application 220, such as in response to a user input (e.g., an employee or game commissioner input) via a game user interface (not shown) on I/O 216. The printed sheet 300 can then be distributed to potential game players (e.g., customers) at the facility 110 prior to the game period and the players manually complete the game sheets 300. In other embodiments, the game sheets may be provided electronically via the network 104 to potential players such as by email with an attachment of the sheet 300 or a link to the sheet 300 that may be provided online in the system 300. The filled in sheet 300 is then used to enter the player data 146, 150 that is transmitted to the game management system 300 for use in generating results 148, 152, 156, 160.

The game sheet 300 may be provided as a single sheet (or screen) or a set of sheets. In one embodiment, the game sheet 300 is a document that is handed to a participant when they request to participate in the contest at the facility 110. The participant fills in the relevant portions of the form and turns it into the restaurant employees for entry of the player data 146, 150. The game sheet 300 may take a number of forms and will vary widely with each fantasy sport (such as football, baseball, basketball, golf, soccer, or the like). The game sheet 300 and much of the following discussion describes a particular professional football-based fantasy sports game that may be provided or operated by the system 100. However, this example is used only to fully discuss the features of the invention and not as a limitation as it will be understood that the invention can be used to implement a fantasy sports game for nearly any sporting event or game.

As shown, a header 310 is provided at the top for presenting the title of the sheet 300 and with an advertising portion or element in which the restaurant name and logo along with its location and any other facility-specific leaderboard data 166. Directly below the header are four sections of text in a textual portion 320. The first section 322 is a “how it works” section that includes text or content that describes the contest and what participants are required to do to participate or become game players, such as selecting a team of 7 roster spots that consist of 1 QB, 2 RBs, 2 WRs, 1 Kicker, and 1 Defense/Special Team.

According to one aspect of the invention, individuals or game players are allowed a total salary cap for these roster spots. In the example shown, the game player cannot exceed a $25 salary cap (typically, this is only representative of a salary cap with the game being offered at no charge for customer, i.e., the customer does not have to provide $25 or any other dollar amount to fill out a game sheet). It is explained in this section 322, that if their team scores the most points, they are the winner. The second section of text content 324 is a “How to use Game Sheet” section that provides simple steps to take to utilize the game sheet, including filling in the personal contact information, circling the players' names to make a selection, ensuring that the game player does not exceed the salary cap, and returning the sheet to an on-site commissioner or their server or other employee. The third section of text content 326 describes the scoring system (or point calculation rules 136) used by the results generator 134, and how many points the participant will garner for their selected team when professional players achieve certain things on the field. Several examples include getting 6 points for a passing or rushing touchdown, getting 3 points for kicking a field goal, receiving 1 point for every 50 yards of passing, and the like. The offensive players also can earn bonus points for exceeding 300 yards passing or 100 yards rushing or receiving or the like. The defense also receives points based on the number of interceptions, sacks, points given up, fumble recoveries, and the like in this example. The fourth section of text content 328 details the contest or game schedule, showing which games will be played in a first game period or in an “early” game period (for example, beginning at 1 pm east coast time) and which ones will be played in a second game period or “late” game period (for example, beginning at 4 pm east coast time). An entry deadline for turning in their game sheets 300 is also typically provided, such as at the beginning of the game period or a predefined amount of time before the start of the game period that the player wishes to join.

The game sheet 300 may be configured for presenting facility-specific or other sponsor data 166, 168. This may be provided in one or more sponsor areas 330, 342 in the game sheet 300. The sections or areas 330, 342 enables the game provider or operator of onsite game system 114 to create and display marketing messages of their own, including a logo or data, if desired or of other sponsors (e.g., of a chain that includes the facility 110, of the game generator or operator of the game management system 120, of sponsors of the fantasy game, or the like).

A data entry section or portion 346 of the sheet 300 includes blank boxes where the participant fills in his/her registration information including, for example, first and last name, phone number or email address, and the team name (e.g., player name or identifier) they want to see displayed on the leaderboard 228. Above this is a label 344 that states which game period the sheet 300 pertains to such as the “early games” and for what date. Another data entry section 350 is provided that includes a box for each fantasy player selection and a corresponding box that can hold the selected player's salary or game value that is used in determining compliance with a salary cap. There is a box for “total team salary”, a box for designating an employee versus customer or standard game player, and a box for designating a new player.

The sheet 300 also includes a player information area or section 360 that includes 5 columns 361 of names and numbers. Each column 361 holds a predefined number of player names 366, their corresponding rank 362 and salary value 364, the team they play for, and the team 368 they will be playing against during the game period. Preferably, in this section 360, only those players playing in the “early” games or in the appropriate or corresponding game period are listed in the columns 361. In this example, there is a column 361 for quarterbacks, a column 361 for running backs, a column 361 for wide receivers, a column 361 for kickers, and a column 361 for defenses but of course, other embodiments of the invention may use differing numbers of columns 361 with the same or differing content. To indicate their input or data 146, 150, participants or game players may either circle the player selections in the section 360 or write their numbers into the boxes in the data entry section 350. The bottom section 370 of the sheet 300 has room to include game information (as shown) or another tailored marketing message input, such as by the restaurant itself, each week as part of leaderboard data 166 or sponsor data 168. Each game sheet 300 will be specific to a particular game period and the content of the sheet in sections 328 and 360 (and marketing sections 312, 330, 342, 370) may be unique to the game period and change for each such game sheet 300.

As noted above, the completed game sheets 300 typically are provided to employees or operators of the onsite game system 114 for entry of the data and transmittal of the player data 146, 150 to the game management system 120. In some embodiments, though, the players enter their data via email or other data entry forms themselves and this data is transmitted to the game management system 120 directly or via the onsite game system 114 (or both data entry techniques may be performed in parallel). To assist game commissioners or game system operators (e.g., employees), the onsite game management application 220 preferably operates to present a user interface or GUI via the I/O 216. For example, the input screens 400, 500, 600 of FIGS. 4-6 may be created and displayed to the game operator or commissioner.

Referring to FIG. 4, the operator input screen 400 includes a network or Web address 404 for the input screen 400, e.g., an address for a web page operated by the game management mechanism 130 or other component of the game management system 120 to allow the game commissioner to provide the player data 146, 150 to the system 120. In this example, the game commissioner at each facility 110 logs onto the web site of the game management system 120 and selects an appropriate date and time or game period (such as through the selection or set up input portion 408). The commissioner or operator then can enter participant or game player data via input boxes such as the team or player name 410 or by customer name for repeat customers or players in box 412. Input buttons 414, 416 may be provided to allow the operator to navigate to other earlier screens or to reload lists. Section 418 of screen 400 may provide data regarding the selected game such as indicating when the contest or game is closed to additional entry of participant data (or by which time the game commissioner should have received such input to avoid cutting off participation due to data entry delays and the like at the facility 110). In data entry section 420, the commissioner or operator enters the game player data 146, 150 such via text boxes with or without pulldown lists or other data entry tools. Other entry buttons or components 422, 424, 426 may be provided in the screen 400 to assist the operator in saving input data or deleting and/or refreshing the screen 400, and for returning to a home or earlier screens (not shown), in which other actions such as launching a leaderboard 170, 228, selecting or announcing winners and their assigned prizes, or the like.

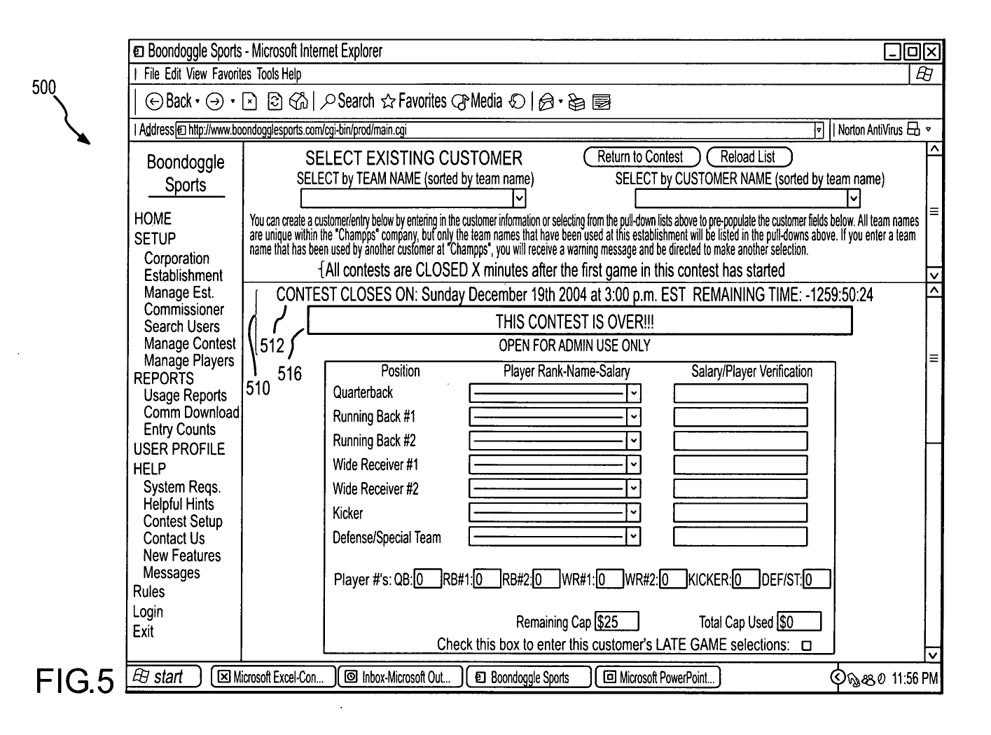

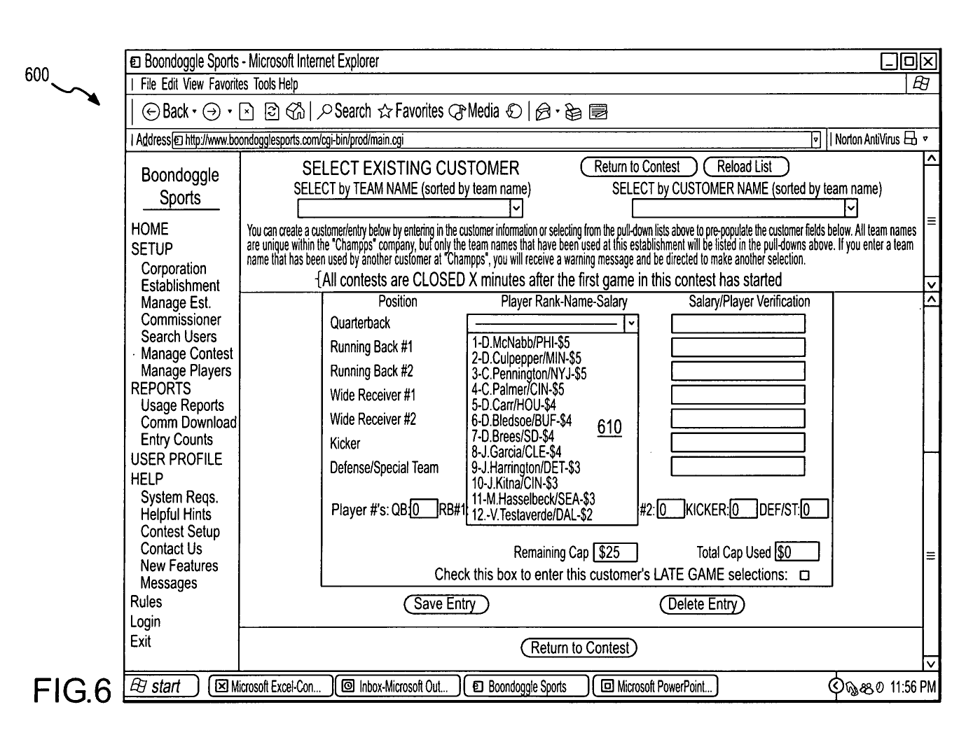

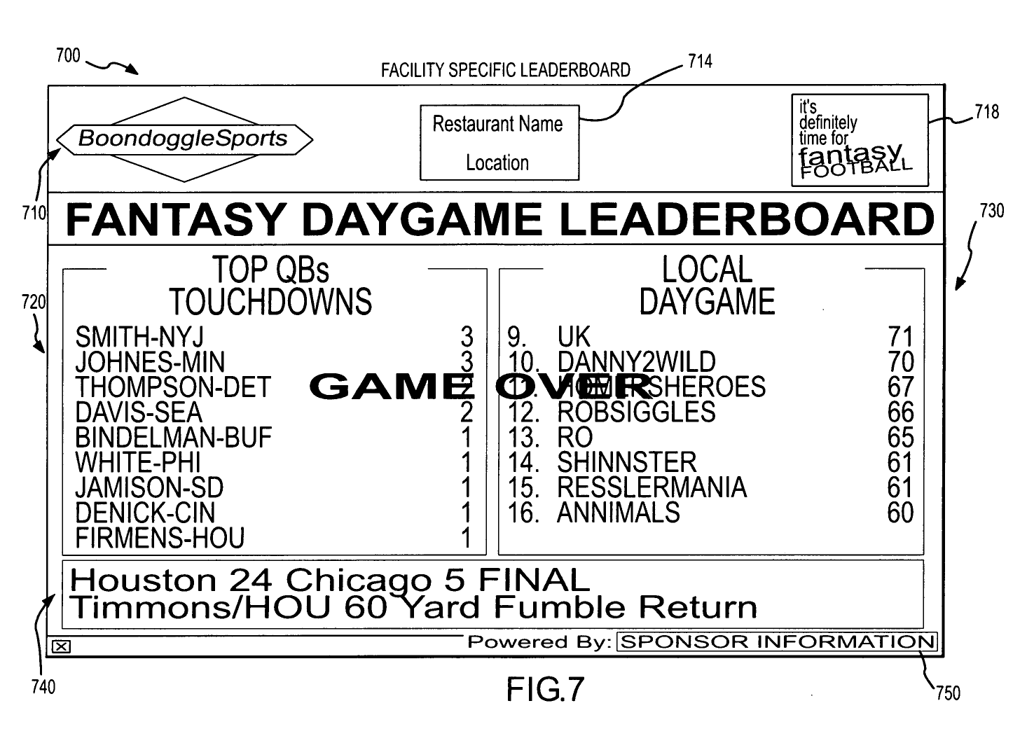

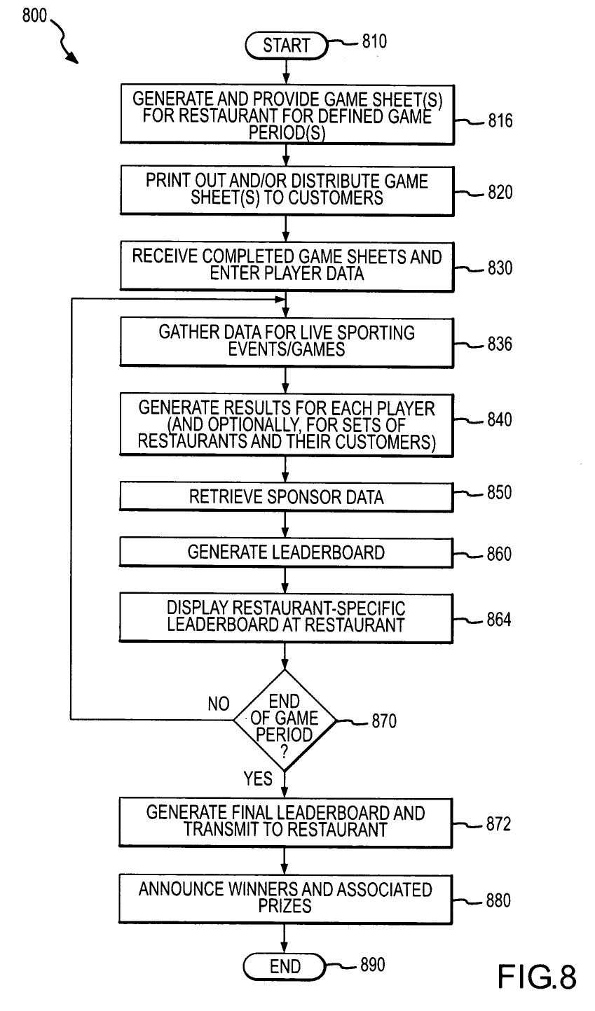

The user screen 500 of FIG. 5 is similar to screen 400 but further includes an updated contest data section 510 that is used to provide updated contest or game data 512, e.g., when the contest or game closes and a remaining time for data entry and/or until the end of the contest (if a set time or an estimated time end if dependent on completion of all games started or played within a game period). The contest information section 510 may also include an announcement that the contest is over indicating that no new participant data can be entered. FIG. 6 is provided to show a screen 600 in which the operator has chosen to use a pulldown list 610 that includes game data that can be selected to designate or enter player data 146, 150 that is stored in memory 140 when the save entry button 422 is selected by the operator, which simplifies data entry by the game commissioner.

The system 100 is adapted for generating facility-specific leaderboards 170 as discussed with reference to FIG. 1 that are delivered, such as Web pages or other format documents that are formatted for transfer over the network 104. FIG. 7 illustrates an exemplary leaderboard 700 that may be used to practice the invention and displayed as leaderboard 228 display device 224 at the onsite facility 110. As shown, the leaderboard 700 includes a header or top banner 710 that can be used to present facility specific leaderboard data 166, such as the name and location of the facility 110 or the like and or game data in a first area 714 and to present facility-specific, game operator-specific, facility group-specific, geographic specific, or other sponsor data 168. For example, a sponsor area 718.

The leaderboard 700 also has a game data portion or area 720 used to display game data 144. More importantly, an result area 730 is provided to present facility-specific game results 156 (such as the leaders of the game or contest of the present game period) and/or game results for a set of facilities 160 such as leaders for all players at a chain of restaurants, bars, or other facilities 110. The “local” or facility-specific data 156 in area 730 may be configured to include the players rank in the larger or group of facilities contest, too (as shown), but this is not required. A “Game Over” banner or label may be presented in one or both areas 720, 730 (or elsewhere on leaderboard 700) to indicate that this is the final leaderboard and the results are final for this contest or game period. Another display area 740 may be provided in the leaderboard 700 for displaying real time game data 144 that provides scores and statistics of games or events relevant to the contest or game period associated with the fantasy sports game being run by system 100. Additional sponsor information areas 750 may be provided at the bottom or throughout the leaderboard 700 for displaying the sponsor data 168 or affiliated companies.

The generation and presentation of the leaderboard 700 is an important part of the invention, and it may be useful to more fully describe leaderboards of the invention. In many embodiments, the leaderboard 700 is a web page that is displayed on the restaurant's or facility's 110 TV monitor or other display 224. Real-time statistics 144 flow to memory 140, e.g., a database server or the like, of game management system 120, which in turn converts that data 144 in combination with player data 146, 150 to scoring points 148, 152 for each participant's team. In one embodiment, the data on the leaderboard 700 (such as data in area 720 or 730) gets updated about 90 seconds after the real activities take place in the corresponding real or live game.

Generally, the leaderboard's contents are divided into four sections. A header 710 that is the top of the page where the game operator and other sponsorship/advertising data is displayed in section 718, the logo and location of a particular restaurant or facility (if they choose) in section 714, and the logo(s) of any sponsor who is aiding the restaurant or facility 110 in the promotion of the contest. The board 700 includes a main body right 730, which is the section where the participants' team names are listed in rank order. There may be several contests going on simultaneously (such as facility-specific, group of facilities results, and the like), and the section 730 displays a predefined number of the top players for each one (such as top 10 to 50 or more). One contest may be thought of as “local game” or facility-specific game results, which includes all those customer participants in the immediate restaurant or facility 110 for the short-term contest for a game period (such as the 3 to 5 hour period in which a set of professional or collegiate games are played). Another contest may be the national game or set of facilities game results, which includes all those customer participants or game players within that chain restaurant (or other grouping of facilities) all across the country (or within a defined geographic area or other subset of the chain facilities) playing the short-term contest for a particular game period. Another contest may be local season, which includes the season-long scores for those customers in the immediate restaurant (and this data would be stored in player results 148 of memory 140 or elsewhere in system 100). Another contest may be national season, which includes season-long scores for all those customer participants within that chain restaurant all across the country (or other grouping of facilities). Other contests may include employee results and may include displaying results for the employees for all four previously described contests (i.e., where employee results 152 are used rather than the customers of the facility 110).

The leaderboard 700 further includes a main body left 720, which is the section where statistical performance of players in the real or live games are displayed. The leaderboard generator 138 may cycle through each relevant position in the underlying sport. In a football embodiment, the positions may include quarterback, running back, wide receiver, and kicker and include other scoring elements such as the defense. For each, the results generator 134 calculates the fantasy points scored 148, 152, and then, the leaderboard generator 138 includes several categories of relevant statistical categories appropriate for that position in the section 720. For example, the quarterback screens in section 720 will show fantasy points, touchdowns thrown, passing yardage, rushing yardage, interceptions, fumbles, and the like that would have been awarded if that player had been selected for a fantasy team of a game player as indicated in the player data 146, 150. For running backs, the leaderboard 700 in section 720 or elsewhere may display fantasy points, rushing yardage, receiving yardage, rushing touchdowns, receiving touchdowns, fumbles, and the like. For wide receivers, the leaderboard 700 in section 720 may display fantasy points, receiving yardage, receiving touchdowns, fumbles, and the like. For kickers, the board 700 in section 720 may display fantasy points, field goals made, and extra points made. For defenses, the board in section 720 may display fantasy points, sacks, interceptions, touchdowns, fumble recoveries, safeties, and the like. The local game section 730 of the board 700 may be used to display current scores and/or standings for local players of the fantasy game along with their game identification or name. The leaderboard 700 may also include a scrolling ticker 740 along the bottom of page 700 (or at another location). This box 740 can be used by the leaderboard generator 138 to give real-time updates on the scores of the games in the game period as they happen (or with some acceptable delay), as well as displaying marketing messages defined by the facility 110 and/or the operator of the game management system 120 in section 750.

FIG. 8 illustrates generally a method 800 of providing an onsite fantasy sports game at a particular facility with onsite data collection and network-based support. The example is described with reference to the system 100 and the onsite facility 114 of FIG. 2 and is explained with the facility being a restaurant for ease of discussion (not as a limitation). As shown, the method 800 starts at 810 typically with determining which real or live games will be used as the basis of the onsite fantasy game, such as football, basketball, baseball, hockey, soccer, golf, auto racing, or the like and what game periods will be used (such as games played a particular day or within a particular time period of a day, or that at least start during that time such as the early or late games for professional football, such as baseball or other games that start at a particular time, or the like). As discussed earlier, the definition of the game period may vary to practice the invention and will likely vary across that various sports but generally is selected to define a relatively short time period such as several hours or the like. Step 810 may also include establishing the game management system 120 and its links and interfaces with the game data source 180 and with one or more onsite facilities 110. Step 810 may also include defining which groups of facilities 110 will be tracked in element 160 and whether employees will be allowed to play and which contests they will participate in during operation of the system 100. Note, the system 100 may operate concurrently to run more than one fantasy sports game as it is common for sporting seasons to overlap and the facilities 110 may participate in one or more of such fantasy sports games (e.g., may participate concurrently in games based on professional football and baseball or football, basketball, and hockey, or the like).

At 816, the method 800 continues with generating with the game sheet generator 132 one or more game sheets 142 that are then distributed to the onsite game systems 114 for storage 234 in memory 230. At 820, the onsite game system 114 prints out the game sheets 234 and distributes them to customers or potential game players (or the sheets may be distribute via email or by other methods). At 830, the completed game sheets are received, such as by an employee of the facility, and player data 146, 150 is entered, such as via a web page as discussed with reference to FIGS. 4-6. At 836, the method 800 continues with gathering data for live sporting events or games during the game period corresponding to the game sheet for which data was entered, such as by operation of the game data source 180 to collect and process statistics and then, transfer the data 184, 188 to game management system 120 for storage 144 in memory 140.

At 840, the results generator 134 acts to generate results for each player 148, 152 and for facilities 156 and, optionally, for groups of such facilities 160. At 850, sponsor data 168 is retrieved along with the results 156, 160 by the leaderboard generator 138 and at 860, the generator 138 acts to generate a leaderboard at 860 (such as the leaderboard 700 shown in FIG. 7). At 864, the leaderboard 170 is transferred for storage (or immediate display) as received leaderboard 238 and then, the onsite game management application 220 displays the leaderboard 238 selectively on one or more of the display devices 224 as displayed leaderboard 228.

At 870, the game management system 120 determines whether the game period is ended, such as with determining if all games scheduled for play during a game period have ended or comparing the elapsed time from the start time to a preset game period length (such as 3 to 5 hours or the like). If not, the method 800 continues at 836 with collection of additional real time or live game data and generating further results 840 (e.g., updating results on an ongoing basis that are shown in updated leaderboards). If the game period is over, the method 800 continues at 872 with generating a final leaderboard including generating a final set of results 148, 152, 156, 160. The final leaderboard is transmitted or made available to the onsite game system 114. The onsite game system 114 may operate to display the final leaderboard with an indication that the game period or contest is over and that the displayed results or game player ranking is final. At 880, the onsite game management application 220 may be adapted to allow a game commissioner or facility employee to indicate who the winners are and what prizes are being awarded (or alternatively, this may be done automatically by the game management system as part of generating the final leaderboard with the generator 138, which would involve prize data being stored in memory 140 or made available to the game management system 120. Alternatively, step 880 may be performed manually at the onsite facility 110 (such as over a loudspeaker system or the like or via a separate display on the display device 224 rather than as part of the leaderboard 228). At 890, the method 800 ends, which may include initializing the game management system 120 for a next game period (or data 146, 150 for a next game period may be entered during a first game period, e.g., such as entry of a late game period for professional football during the first or early game period).

Although the invention has been described and illustrated with a certain degree of particularity, it is understood that the present disclosure has been made only by way of example, and that numerous changes in the combination and arrangement of parts can be resorted to by those skilled in the art without departing from the spirit and scope of the invention, as hereinafter claimed.

I claim:

1. A computer-based method for running a fantasy sports game at an onsite facility, such as a restaurant, bar, or the like, with network-based support, comprising:
selecting a game period for playing the fantasy sports game, the game period being defined as a portion of a single day corresponding with occurrence of a set of sporting events;
generating an input form for the fantasy sports game comprising a set of game elements corresponding to the set of sporting events for the game period;
transferring the input form to the onsite facility via a communications network;
receiving player data via the communications network, the player data indicating selections of subsets of the game elements by a plurality of game players associated with the onsite facility; and
generating results of the fantasy sports game for the game players based on data for the set of sporting events and the player data.

2. The method of claim 1, wherein the results generating comprises during the game period periodically gathering the data for the set of sporting events and calculating points for the game players based on the player data and point calculation rules for the fantasy sports game.

3. The method of claim 2, wherein the results generating further comprises determining the game period has ended and generating a final set of the results of the fantasy sports game, the method further comprising transmitting the final set of the results to the onsite facility.

4. The method of claim 3, wherein the determining the game period has ended comprises determining each of the sporting events has been completed.

5. The method of claim 1, wherein the set of sporting events is a subset of all of the sporting events occurring on the single day of the fantasy sports game, wherein the sporting events comprise at least one of football games, soccer games, baseball games, hockey games, basketball games, golf games, and motor vehicle racing, and wherein the set of game elements in the input form comprise participants in the subset of all of the sporting events.

6. The method of claim 1, wherein the results generating comprises creating a leaderboard including the results for the game players associated with the onsite facility, wherein the leaderboard comprises a web page transmitted over the communications network.

7. The method of claim 6, further comprising repeating the input form transferring, the player data receiving, and the results generating for a plurality of the onsite facilities, wherein the results generating comprises combining the results for the game players from all the onsite facilities and wherein the leaderboard further includes the results for the game players at the plurality of the onsite facilities combined with the results for the game players at the onsite facility.

8. A network-based method of providing a facility-specific fantasy sport game environment, comprising:
with an onsite game system at an onsite facility, inputting player data for a plurality of game players that defines a set of game element selections for a set of sporting events held within a game period;
transferring the player data from the onsite facility to a game management system over a communications network;
during the game period, operating the game management system to generate game results for the game players by processing data for the set of sporting events and the transferred player data, to generate a leaderboard including the game results, and to transfer the leaderboard to the onsite facility over the communications network; and
with the onsite game system, displaying the leaderboard on a display device at the onsite facility.

9. The method of claim 8, further comprising operating the game management system to generate a game sheet for the onsite facility comprising information specific to the onsite facility and a listing of game elements that can be selected by the game players for the set of sporting events and transferring the game sheet to the onsite facility over the communications network prior to the player data inputting.

10. The method of claim 8, wherein the generating of the leaderboard comprises retrieving sponsor data for inclusion in the leaderboard, the sponsor data comprising at least some sponsor data specific to the onsite facility.

11. The method of claim 8, wherein the game period is a period of time less than about 5 hours.

12. The method of claim 8, further comprising after the game period, operating the game management system to generate a final set of the game results for the game players, to generate a post game period leaderboard including the final set of the game results, and to transfer the leaderboard to the onsite facility over the communications network.

13. The method of claim 12, further comprising operating the onsite game system to designate a subset of the game players as winning players based on the final set of the game results and to assign a prize to each of the winning players, wherein at least one of the prizes relates to operation of the onsite facility.

14. A system adapted for supporting operating fantasy sports games onsite at particular facilities, comprising:
a game management system linked to a communications network, the game management system comprising memory and a game management mechanism generating an input sheet for a fantasy sports game for a game period and storing the input sheet in the memory, the input sheet defining a set of game elements for a set of sporting events occurring during the game period; and
a plurality of onsite game systems located at a plurality of geographically dispersed facilities and linked to the communications network, each of the onsite game systems adapted for receiving the input sheet, inputting player data for game players based on a plurality of the input sheets received from game players at the facilities, and transferring the player data to the game management system;
wherein the game management mechanism generates game results for each of the onsite game systems at each of the facilities based on data for the set of sporting events and on the transferred player data and transfers the game results to each of the onsite game systems over the communications network.

15. The system of claim 14, wherein the game management mechanism generates a leaderboard for each of the onsite facilities including facility-specific information and including the game results specific to the onsite facility corresponding with the facility-specific information and the game management mechanism transfers one of the leaderboards corresponding to the onsite facility to each of the onsite game systems, and wherein each of the onsite game systems comprises a display device for displaying the transferred leaderboard in the corresponding onsite facility.

16. The system of claim 15, wherein the game management mechanism further combines the game results for a predefined set of the onsite facilities and wherein the generated leaderboard for the onsite facilities in the predefined set further comprises the combined game results.

17. The system of claim 14, wherein the game period is defined as having a starting time corresponding to an earliest starting time for the set of sporting events and an ending time corresponding to a latest ending time for the set of sporting events.

18. The system of claim 17, wherein the game period is less than about 24 hours.

19. The system of claim 17, wherein the set of game elements comprises participants in the set of sporting events and excludes participants in sporting events not in the set.

20. The system of claim 14, wherein the game results comprise a point total for each of the game players calculated based on a set of point calculation rules, on the player data for each of the game players, and the data for the set of sporting events, and wherein the game results are generated periodically during the game period and after completion of the game period.
